(19) United States
(12) Patent Application Publication
(10) Pub. No.: US 2014/0112638 A1
(43) Pub. Date: Apr. 24, 2014

(54) DUAL STAGE HYBRID DRIVE

(71) Applicant: QUANG NGUYEN, Toronto (CA)

(72) Inventor: QUANG NGUYEN, Toronto (CA)

(21) Appl. No.: 14/059,264

(22) Filed: Oct. 21, 2013

Related U.S. Application Data
(60) Provisional application No. 61/716,729, filed on Oct. 22, 2012.

(51) Int. Cl. H04N 5/765

(52) U.S. Cl. CPC H04N 5/765
USPC 386/231

(57) ABSTRACT

Mobile Device Video Recorders (MDVR) are used to track the motion, position and events on various types of vehicles ranging from cars to airplanes. The present invention uses a dual stage hybrid drive (DHD) which stores data on an HDD during conditions favorable to HDD operation and stores data on FMC or SSDs during conditions outside of optimal HDD operation thresholds. Recorded data from the SSD or FMC can be transferred to the HDD while the vehicle engine is off or during times of optimum HDD function while the vehicle is operating.

### RELATED APPLICATION

This application claims the benefit under 35 U.S.C. 119(e) of U.S. Provisional Patent Application Ser. No. 61/716,729 filed Oct. 22, 2012, which is incorporated herein by reference in its entirety and made a part hereof.

### FIELD OF INVENTION

The present invention relates to Mobile Digital Video Recorder (MDVR) and Dual Stage Hybrid Drive (DHD) type of MDVR.

### BACKGROUND OF THE INVENTION

Mobile Digital Video Recorder (MDVR) is a recording device installed on vehicle, vessels or airplane that records the digital information onto a Data Storage Device (DSD). Digital information includes digital format of video and audio signals, GPS data, temperature, vehicle speed, and other vehicle data. The MDVR may have an analog to digital convertor to convert the video and audio analog signals from analog cameras and microphones to digital format. The MDVR may have one or more network interface to connect to IP cameras, which provide the digital format of the video and audio signal.

MDVRs that use a Hard Disk Drive (HDD) as a digital storage device have to turn on power to the HDD during the recording. If the MDVR is recording for 18 hours out of 24 hours a day, the HDD has to be powered on for at least 18 hours out of 24 hours. With the HDD running for that period of time per day, the ambient temperature of the HDD can be over 60° C. from heating or less than −10° C. from environmental conditions, additionally the HDD can be subjected to excessive shock and vibration. All of these factors can significantly reduce the service life of the HDD.

On the other hand, an MDVR that uses Flash Memory Card (FMC) for DSD is more robust but has less storage space for the same cost as MDVR using HDD for DSD. The HDD has large storage space but it contains moving parts and has limited operating conditions. The HDD may not be used when the operating temperature is less than −5° C., in addition, the HDD may not be used when the operating temperature is greater than 60° C. The HDD's reliability is dramatically reduced when it is operating in an environment with temperatures higher than 50° C. and in an environment where it is constantly subjected to shock and vibration. Operating the HDD in an excessive shock or vibration environment will reduce its service life and will cause permanent damage to the HDD and a loss of data.

The prior art discloses attempts at protecting the HDD from vibration and shock. U.S. Pat. No. 7,768,548 describe a ruggedized multiple video and audio input system to be placed in vehicles. However, the described device does not describe any sensors for temperature, shock or otherwise for monitoring the state of the recordable drive. Additionally, the devices solely relies on a HDD which in case of failure would lead the device unable to store recorded data.

Avoiding storage devices with moving parts in order to increase reliability has been attempted in the prior art. U.S. application Ser. No. 10/691,483 discloses an in-car video system that uses flash memory for storage. While flash memory cards are reliable and do not posses any moving parts, they do have limited write cycles requiring eventual replacement. As well, the storage capacity of flash memory is severely limited compared to HDDs.

EP Application No. 2064706 A1 filed by Bisson and Oullette describes a mobile event recorder containing a vibration isolation system surrounding hard drive housing and enclosed within a hard drive module chassis. This device only isolates the HDD(s) from ambient vibrations and does not contain system for removing power from the HDD during excessive vibration outside of the defined vibrational range of this device, as well as in low or high temperatures as in the present invention. It also does not describe multiple storage devices such as an FMC or SSD.

U.S. Pat. No. 5,860,083 issued to Hiroshi Sukegawa discloses a data storage system using a flash memory unit and an HDD. The flash memory is dived into a permanent storage area, a non-volatile cache area and a high-speed access area. This device is designed to use the cooperative functions of the flash memory and HDD and allow for efficient use of the data storage system. The described system does not use regulate the function of the HDD based on environmental sensor and does not transfer data during defined times and operating ranges as the present invention. It also does not contain inputs for the storage of video, audio and sensor data as the present invention.

### SUMMARY OF THE INVENTION

The present Removable Dual Stage Hybrid Drive (RDHD) is a digital storage device comprising of a metal or plastic enclosure that houses one or more Hard Disk Drives, one or more Flash Memory Cards or Solid State Drives (SSDs), one or more connectors to the MDVR, which provide the USB interface signals, SATA signals, and/or control signals between the RDHD and the MDVR, and which provide power to the RDHD, and control signals to turn on and off the power to the HDD on the RDHD. Removable Dual Stage Hybrid drive can be removed from the MDVR easily by opening a door on the MDVR using mechanical and/or electronic keys and/or by loosening one or two screws that hold the RDHD onto the MDVR.

A Fixed Dual Stage Hybrid Drive is a digital storage device that may comprise of one or more print circuit board; one or more HDD connector/s; one or more SSD; and may or may not have SSD Connectors; one or more HDD/s; and one or more connectors to the MDVR, which provide the interface and control signals between the Fixed Dual Stage Hybrid Drive and the MDVR, and which provide power to the Fixed Dual Stage Hybrid Drive, and which provide control signals to turn on and off power to the HDD on the Fixed Dual Stage Hybrid Drive. The Fixed Dual Stage Hybrid Drive can be removed from the MDVR by loosening up one or more screws on the enclosure of the MDVR.

The present MDVR has a sensor that determines whether the vehicle engine is on or off. The MDVR turns off the power to HDD and records the digital information onto FMC or onto SSD when the engine is on. The MDVR turns on the power to the HDD when the vehicle engine is off and copies new digital Information from the FMC or SSD to the HDD.

Furthermore, the present MDVR has a sensor that determines the vehicle movement. If the vehicle is moving, the MDVR turns off the power to the HDD and records the digital information onto FMC or onto SSD, when the vehicle is moving. It turns on the power to the HDD when the vehicle is not moving and then copies the digital information from FMC or SSD to HDD, and/or records to the HDD directly.

Furthermore, the present MDVR has a vibration sensor that determines and measures any vehicle vibration. The MDVR turns off the power to the HDD and records the digital information onto the FMC or onto the SSD if the vibration level is beyond a pre-specified threshold. It turns on the power to the HDD when the HDD is not subjected to excessive shock or vibration.

Furthermore, the present MDVR has a temperature sensor that determines the HDD temperature. The MDVR turns off the power to the HDD and records the digital information onto the FMC or onto the SSD when the temperature is beyond a safe pre-specified temperature range. It turns on the power to the HDD when the HDD temperature is within the safe temperature range and then copies the digital information from the FMC or the SSD to the HDD and/or records digital data on to HDD. The safe temperature range can be configured by the user.

The present invention provides a MDVR that uses less power, generates less heat, runs cooler and is more reliable than conventional MDVRs. The present MDVR can have an FMC or an SSD and HDD. The MDVR can have an FMC or SSD and a Removable Dual Stage Hybrid Drive (RDHD). The MDVR can have an FMC or SSD and a removable HDD. The MDVR can have an FMC or SSD and a Fixed Dual Stage Hybrid drive (FDSM).

The present invention has the following objectives:
a. Reduce the power consumption of the MDVR that uses an HDD as the Data Storage Device;
b. Provide a Data Storage Device for MDVR that has the large storage capacity of an HDD and can have the operating conditions of an SSD or FMC;
c. Increase the service life of the HDD that the MDVR uses as Data Storage Device; and
d. Increase the reliability of the MDVR.

The present invention provides a MDVR that can meet the objectives of this invention and will possess a recording process that can reduce power consumption of the MDVR and can increase the reliability of the HDD.

### BRIEF DESCRIPTION OF THE DRAWINGS

Embodiments herein will hereinafter be described in conjunction with the appended figures provided to illustrate and not to limit the scope of the claims, wherein like designations denote like elements, and in which,

FIG. 1 shows the Mobile Digital Video Recorder MDVR with the present invention (a) the front side, and (b) the back side;

FIG. 2 shows the RDHD with the (a) connections on the front and (b) the HDD and FMC with the back panel open;

FIG. 3 shows the circuit board contained inside the RDHD; and

FIG. 4 shows the schematic view of the various connections of the MDVR.

### DETAILED DESCRIPTION OF THE INVENTION

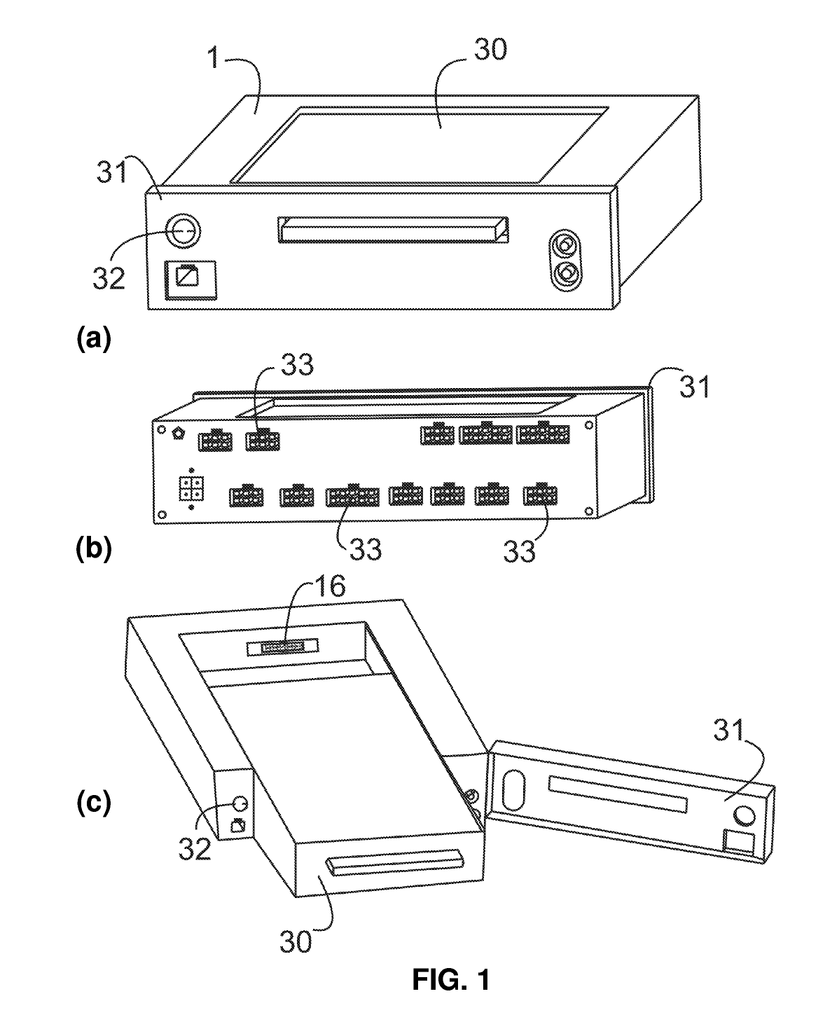

Referring to FIG. 1 the overall structure of the MDVR 1 comprises of an RDHD 30 connected to a host MDVR. The casing of the MDVR 10 and RDHD 30 can be made of metal, plastic or other comparable material. The RDHD 30 can be removed slidably from the MDVR. For security purposes, the RDHD 30 can be secured using a door 31 and a lock 32 and key mechanism. The MDVR contains a plurality of connections in the back 33 and in the front 33. The host MDVR 2 is connected to the RDHD 30, and monitors the sensors of the DHD and regulates the function of the HDD 13.

Again referring to the FIG. 1, the panel is shaped and sized to receive an RDHD 30, wherein the RDHD 30 is mounted slidably and detachably onto the panel. A locking system for securing the RDHD 30 onto the host MDVR 2 is installed on the panel 15. The locking system may comprise of a door 31, connected on the panel host MDVR 2 with a set of hinges. The door 31 may be closed and locked after RDHD 30 is installed in place. The RDHD 30 can be removed from the device and it can be connected to a personal computer for transferring the data.

Referring to FIGS. 1-4 The MDVR 1 comprises of an RDHD 30 connected to a host MDVR 2. The RDHD 30 contains an HDD 13 and an FMC 14 or SSD 11. The RDHD 30 may contain only an HDD 12, or may have an HDD 12 and Flash Memory Card 13 or Solid State Drive 14. Alternate embodiments may also have the RDHD be permanently fixed to the host MDVR 2. The RDHD is connected to the host MDVR 2 by the connector 16. The connector 16 provides a USB or a SATA signal interface between the host MDVR 2 and the RDHD 30. The connector 16 also provides control signals 50 and power 51 to the RDHD 30. The MDVR 10 turns on or turns off power 51 to DSD 20. The host MDVR 2 can use the control signals 50 to control the power switch 17 to turn on or off power to the HDD 13 on the RDHD 30. The host MDVR 2 can use the control signals 15 to control the signal & converter and switch 17 to turn on or off data interface signals 5 to HDD 13 on the RDHD 30.

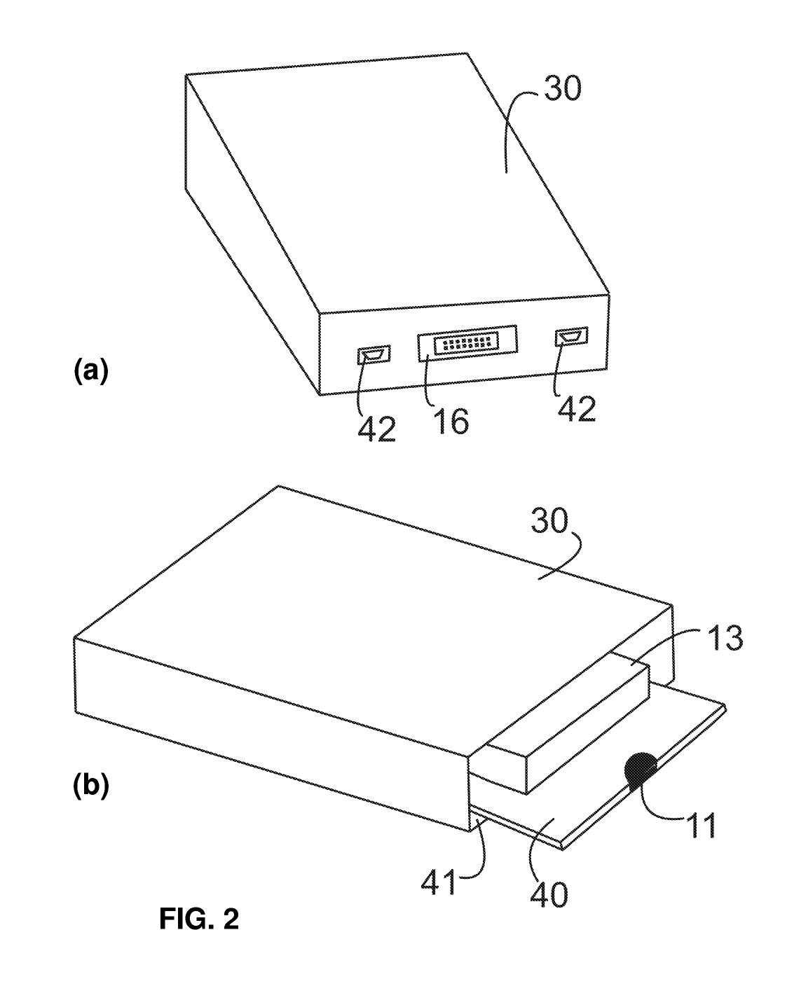

FIGS. 2-4 show that the present invention provides an RDHD 30 comprising: a metal or plastic enclosure that houses one or more than one printed circuit board 60 with HDD connector/s 31 and with FMC 32 or SSD 33 connector/s and with a control circuit that 50 can turn on and turn off power to the HDD 13 and with one or more than one HDD 13 and with one or more than one FMC 14 or SSD 11 and with one or more than one connectors 16 to the host MDVR 2 which provide the USB interface 42 signals or SATA 43 Signals and control signals 5 between the RDHD 30 and the host MDVR 2 and which provides power 4 to RDHD 30 and which provides control signals 5 to turn on and turn off power to the Hard Disk Drive 30 on RDHD 30. The RDHD 30 can slide out of the MDVR 10 easily by opening the door 11 of the MDVR 10 with a mechanical key and/or electronics on the lock 32 key and/or by loosening one or two screws that hold the RDHD 30 onto the host MDVR 2. The host MDVR 2 can power off the HDD 13 and write digital data onto the FMC 14 or SSD 11 inside the RDHD 30; and the host MDVR 2 can power on the HDD 13 and copy data from the FMC 14 or SSD 11 to HDD 13.

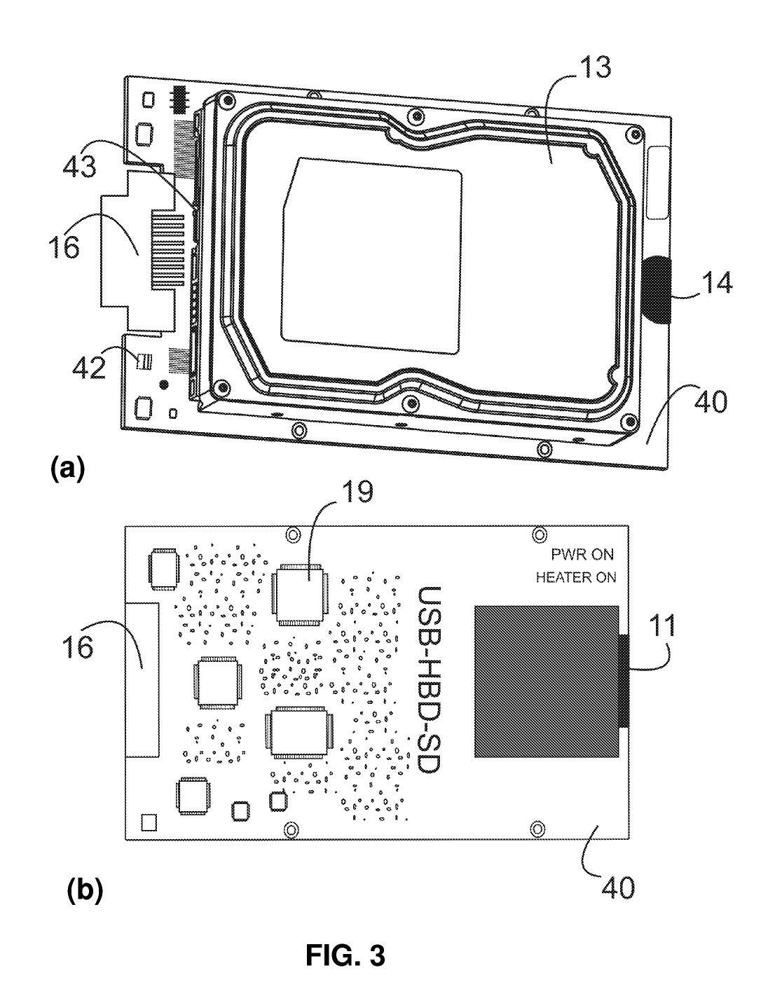

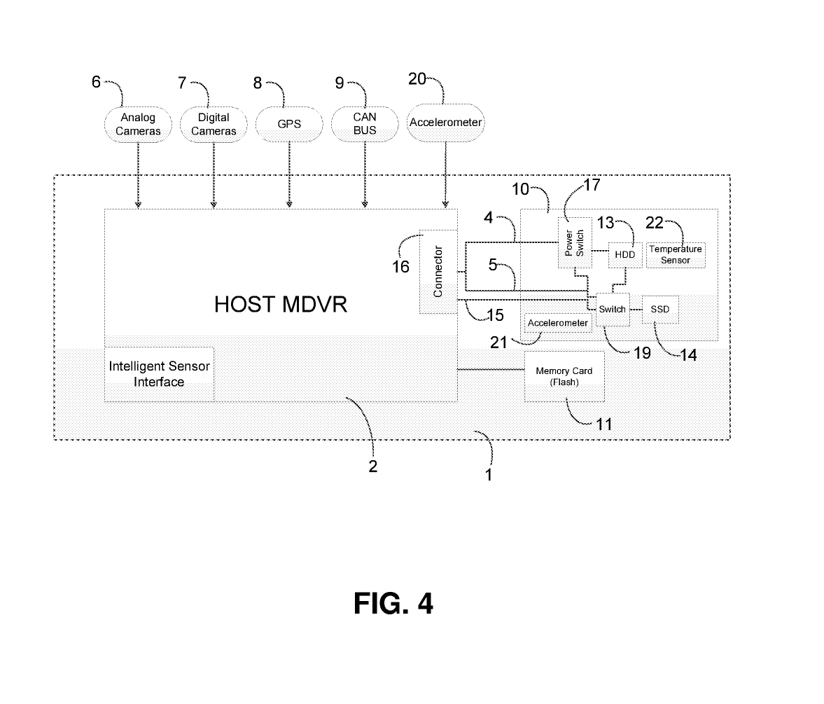

FIG. 3 shows different elements of the RDHD 30 including an FMC 14 and the print circuit board 40. The FMC 14 is connected to a print circuit board 40 electronically. The FMC 14 may be chosen from any available small memory cards. The FMC 14 may be an SDHC Flash Memory Card or an SDXC Flash Memory Card. FIG. 2B shows the rear view of the RDHD 30 with its connector 16 to the MDVR that supplies the power to the board 40 and transfers data from all other devices shown in FIG. 4, such as a camera 6-7, GPS devices 8 and others, to the board 40. Other connectors such as mini USB connectors 42 may also be available to connect the RDHD 30 to a computer. FIG. 4 shows the print circuit board 40 comprising of a hard drive 13, a flash memory drive 14, a connector 16 to the host MDVR 2 with USB or SATA interface signals 15, power, and control signals 5 or 12C bus or UART 43 that are mounted to the board.

As shown in FIG. 3, the inside of the RDHD 30 comprises of a print circuit 40 board, a hard disk drive 13, a flash memory card 14 and other electronic components that all mounted on a print circuit board 40. All data from all elements connected to the host MDVR 2 can be stored on the HDD 13 or flash memory card 14 through the print circuit board 40 and electronic elements with the use of logic theory. The hard drive 13 and the flash memory card 14 are mounted to the board 40. In addition, a USB HUB or SATA connector 16 and USB to SD Interface IC 19 are shown on the print circuit board 60.

Digital information may also include digital GPS data from a GPS Receiver 8, and digital information of vehicle temperature that may come from a vehicle temperature sensor 22 or from a CAN Bus. Digital information may also include vehicle speed that may come from a GPS Receiver 8 and/or digital information that come from CAN Bus. The host MDVR 2 may have one or more network interface to connect to IP Cameras 6-7, which provide the digital format of a video and audio signal.

Using an intelligent sensor interface 12 the host MDVR 2 can gather vehicle information data. Data such as vehicle speed, battery life, oil life, fuel and other data gathered by the onboard vehicle computer can be stored by the MDVR 1.

The data interface 16 between the host MDVR 2 and RDHD 30 can be USB signals or SATA signals. The control signals 5 are 12C bus or UART signals or digital control signals. The host MDVR 2 monitors the vehicle's engine status to determine whether the vehicle engine is running or not. If the vehicle's engine is running, and if the MDVR 1 is set to record while the engine is running, the host MDVR 2 turns off the power to the HDD 13 and then the MDVR 1 records digital information onto the FMC 14 or SSD 11. If the FMC 14 or SSD 11 are not available, when the vehicle's engine is not running and after the MDVR 10 has stopped recording, the host MDVR 2 turns on the power to HDD 13, turns on the signal interface 70 to the HDD 13, and copies the recorded digital information from the FMC 14 or SSD 11 onto the HDD 13.

On another condition, when the host MDVR 2 monitors the vehicle's engine status to determine whether vehicle engine is running, if the vehicle's engine is running, and if the MDVR 10 is set to record while the engine is running, the host MDVR 2 turns off the power to the HDD 13, and it records digital information onto the FMC 14 or SSD 11. When the vehicle's engine is not running and after the MDVR 10 stops recording, the host MDVR 2 turns on the power to the HDD 13, turns on the signal interface 70 to the HDD 13, and copies the recorded digital information from the FMC 14 or SSD 11 onto the HDD 13.

The MDVR 10 can also use the information from a GPS receiver 68 to determine whether the vehicle is moving. If the vehicle is moving, and if the MDVR 10 is set to record while the vehicle is moving, the host MDVR 2 turns off the power to the HDD 13. The MDVR 10 records digital information onto FMC 14 or SSD 11. When the vehicle is not moving and after the MDVR 10 stops recording, the host MDVR 2 turns on the power to the HDD 13, then turns on the signal interface 70 to the HDD 13, and copies the recorded digital information from the FMC 14 or SSD 11 onto the HDD 13.

The host MDVR 2 can monitor the vehicle ignition signal to determine whether the vehicle engine is on. The signal is provided by the vehicle at the time of ignition. When the ignition switch is turned on to start the engine, this signal is above 5V. When the ignition switch is turned off to stop the engine, this signal is less than 5V.

An accelerometer 80 can also be used to monitor the status of the engine. When the accelerometer 80 detects a repetitive vibration created by the engine, the accelerometer 80 sends its data to the host MDVR 2. This signal can be relayed to the vehicle using CAN Bus 69, which is the Vehicle Bus that provides the engine status information.

The host MDVR 2 monitors an additional accelerometer 81 on the RDHD 30 to determine whether the HDD 13 is subjected to excessive shock and vibration. The host MDVR 2 also monitors the HDD 13 temperature to determine whether the HDD 13 temperature is within a safe operating condition. If the HDD 13 is not within the safe operating conditions or if the HDD 13 is subjected to excessive shock and vibration, and if the MDVR 10 is set to record, the host MDVR 2 turns off the power to the HDD 13, and consequently, the MDVR 10 records the digital information onto the FMC 14 or SSD 11. When the HDD 13 is found to be within a safe operating condition and when the HDD 13 is not subjected to excessive shock and vibration, the host MDVR 2 turns on the power to HDD 13, turns on the signal interface 15 to the HDD 13, and copies the recorded digital information from the FMC 14 or SSD 11 onto the HDD 13 and records digital information directly onto the HDD 13.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A Mobile Digital Video Recorder (MDVR) installed within a vehicle for capturing a digitally integrated data in accordance with the present invention comprising:
a. a host MDVR having a plurality of input channels to connect to a plurality of auxiliaries;
b. said auxiliaries generating a plurality of data;
c. a dual stage hybrid drive comprising of a hard drive and a solid state drive connected to the host MDVR;
d. a processor programmed to determine whether the vehicle being in a quiet environment or a noisy environment based on said data;
e. said processor stores said data in said hard drive during quiet environment and in the solid state drive during noisy environment; and
f. said processor transfers the stored data from the solid state drive to the hard drive once the vehicle is in the quiet environment.

2. The Mobile Digital Video Recorder (MDVR) of claim 1, wherein said auxiliaries comprising a temperature sensor to sense the temperature at said dual stage hybrid drive.

3. The Mobile Digital Video Recorder (MDVR) of claim 1, wherein said auxiliaries comprising an accelerometer sensor to sense the movement and the vibration amplitude of said dual stage hybrid drive.

4. The Mobile Digital Video Recorder (MDVR) of claim 1, wherein said auxiliaries comprising a CAN BUS to obtain generic vehicle data.

5. The Mobile Digital Video Recorder (MDVR) of claim 1, wherein said auxiliaries comprising a plurality of cameras, a GPS, a plurality of microphones, and a power supply.

6. The Mobile Digital Video Recorder (MDVR) of claim 1, wherein said quiet environment being:
a. the vehicle's engine being OFF;
b. the vehicle not being in motion;
c. the temperature being between a pre-specified range set by a user; and
d. the vibration amplitude being between a pre-specified range set by a user.

7. The Mobile Digital Video Recorder (MDVR) of claim 1, wherein said noisy environment being any one of:
a. the vehicle's engine being ON;
b. the vehicle being in motion;
c. the temperature being outside of a pre-specified range set by a user; and
d. the vibration amplitude being outside of a pre-specified range set by a user.

8. The Mobile Digital Video Recorder (MDVR) of claim 1, wherein said host MDVR comprising an enclosure having a door, said enclosure shaped and sized to receive said dual stage hybrid drive.

9. The Mobile Digital Video Recorder (MDVR) of claim 1, wherein said dual stage hybrid drive being removable.

10. The Mobile Digital Video Recorder (MDVR) of claim 1, wherein a flash memory card being used instead of said solid state drive.
